(19) United States
(12) Patent Application Publication
(10) Pub. No.: US 2025/0224339 A1
(43) Pub. Date: Jul. 10, 2025

(54) 2-Dimentional Dimethylglyoxime-Iridium (DMG-Ir) Nanosheet, Method for Manufacturing the Same and a Colorimetric System

(71) Applicant: NATIONAL SUN YAT-SEN UNIVERSITY, Kaohsiung City (TW)

(72) Inventors: Hui-Fen Wu, Kaohsiung City (TW); Hemal Weerasinghe, Kaohsiung City (TW); Maheshika Kumarihamy, Kaohsiung City (TW)

(21) Appl. No.: 18/420,826

(22) Filed: Jan. 24, 2024

(30) Foreign Application Priority Data
Jan. 8, 2024 (TW) 113100769

(51) Int. Cl. G01N 21/78; C07F 15/00; G01N 31/22

(52) U.S. Cl. CPC G01N 21/78; C07F 15/004; G01N 31/22; G01N 2201/126; G01N 2201/12746

(57) ABSTRACT

A method for manufacturing 2-dimensional dimethylglyoxime-iridium (DMG-Ir) nanosheet is used to manufacturing the 2-dimensional DMG-Ir nanosheet which can quickly react with a nickel (Ni²⁺) ion and form a coordination complex in crimson red. By the use of the manufactured 2-dimensional DMG-Ir nanosheet, the problem of poor reactivity of the conventional method for detecting the Ni²⁺ ion using DMG can be solved. The method for manufacturing 2-dimensional DMG-Ir nanosheet includes promoting the reaction between iridium (Ir) salt and DMG in a basic environment. Preferably, the promotion of the reaction between the Ir salt and DMG includes dissolving the Ir salt and DMG in an alkaline aqueous solution to form a mixture. The mixture is probe sonicated for a predetermined time with a pulse on time and a pulse off time, and a hydrothermal reaction is further carried out to the resulted mixture. The 2-dimensional DMG-Ir nanosheet manufactured by the method and a colorimetric system are also disclosed.

### CROSS REFERENCE TO RELATED APPLICATIONS

The application claims the benefit of Taiwan application serial No. 113100769, filed Jan. 8, 2024, and the entire contents of which are incorporated herein by reference.

### BACKGROUND OF THE INVENTION

### 1. Field of the Invention

The present invention generally relates to a method for manufacturing a 2-dimensional nanosheet and, more particularly, to a method for manufacturing a 2-dimensional dimethylglyoxime-iridium (DMG-Ir) nanosheet. The present invention further relates to the 2-dimensional DMG-Ir nanosheet manufactured by the same and a colorimetric system.

### 2. Description of the Related Art

Dimethylglyoxime (DMG) is a chemical compound described by the formula CH₃C(NOH)C(NOH)CH₃. DMG can form a coordination complex with nickel ion (Ni²⁺ ion), thus can be used for detecting the nickel ion. However, in the conventional method for detecting the nickel ion using DMG, since DMG takes a long time to form the coordination complex after combining with the nickel ions, the detection efficiency of the conventional method is poor. In light of this, this is necessary to provide a 2-dimensional dimethylglyoxime-iridium (DMG-Ir) nanosheet which can have a fast replacement reaction with the nickel ion, and a method for manufacturing the same.

Moreover, the conventional colorimetric device can automatically identify solutions with different components by distinguishing colors. However, for solution with the same components but different concentrations, the conventional colorimetric device can only determine that they are the same color. That is, the conventional colorimetric device cannot further quantify the color intensity of the solutions, and thus the concentration of the component cannot be determined. In light of this, it is necessary to provide a colorimetric system which is able to precisely identify the color and quantify the color intensity.

### SUMMARY OF THE INVENTION

It is therefore an objective of the present invention to provide a method for manufacturing a 2-dimensional dimethylglyoxime-iridium (DMG-Ir) nanosheet, which is used to manufacture the 2-dimensional DMG-Ir nanosheet which is able to form a coordination complex with a nickel ion (Ni²⁺ ion).

It is another objective of the present invention to provide a 2-dimensional DMG-Ir nanosheet, which is manufactured by the method as mentioned above.

It is still another objective of the present invention to provide a colorimetric system, which can identify a color of an object and quantify a color intensity of the object.

As used herein, the term “a”, “an” or “one” for describing the number of the elements and members of the present invention is used for convenience, providing the general meaning of the scope of the present invention, and should be interpreted to include one or at least one. Furthermore, unless explicitly indicated otherwise, the concept of a single component also includes the case of plural components.

One embodiment of the present invention discloses a method for manufacturing a 2-dimensional DMG-Ir nanosheet, comprising performing a reaction between an iridium (Ir) salt and dimethylglyoxime (DMG) in an alkaline environment. For example, the alkaline environment can have a pH value ranging from 8.5 to 9.5. For example, the alkaline environment can be provided by an alkaline aqueous solution which is formed by dissolving a base in water. The base can be potassium hydroxide (KOH) or sodium hydroxide (NaOH).

Another embodiment of the present invention discloses a 2-dimensional DMG-Ir nanosheet, which is manufactured by the method as mentioned above.

Accordingly, by the above method, the 2-dimensional DMG-Ir nanosheet can be manufactured. The 2-dimensional DMG-Ir nanosheet can form a coordination complex with the nickel ions, so that the color of the aqueous solution containing the nickel ions can quickly change from yellow to crimson red. That is, the two-dimensional DMG-Ir nanosheet can be used for detection of the nickel ions with a preferable detection efficiency.

In the method for manufacturing the 2-dimensional DMG-Ir nanosheet according to the present invention, performing the reaction between the Ir salt and DMG comprising: dissolving the Ir salt and DMG in an alkaline aqueous solution to form a mixture; and after performing a probe ultrasonication to the mixture with a pulse on time and a pulse off time for a predetermined sonicating time, performing a hydrothermal reaction to the mixture. A molar ratio between element iridium of the Ir salt and DMG can be 1:2. The probe ultrasonication can be performed with an output power ranging from 45 W to 55 W. The pulse on time can be 2 seconds, the pulse off time can be 1 second, and the predetermined sonicating time can be 10 minutes. The hydrothermal reaction can be performed at a temperature ranging from 190° C. to 210° C. for a time period ranging from 20 minutes to 30 minutes with a stirring speed ranging from 550 rpm to 650 rpm. For example, the hydrothermal reaction can be performed at a temperature of 200° C. for a time period of 20 minutes with a stirring speed of 600 rpm. As such, the manufacturing efficiency of the 2-dimensional DMG-Ir nanosheet can be improved.

Still another embodiment of the present invention discloses a colorimetric system, comprising: a sensing module; a processing module coupling to the sensing module; and a control module coupling to the processing module. The sensing module is used to measure a color intensity of an object and to convert the color intensity to an analog signal. The processing module receives the analog signal, converts the analog signal to a digital signal, and calibrates the digital signal into a three primary color value signal. The control module receives and verifies the three primary color value signal. The control module converts the three primary color value signal to a color model value. The control module displays the three primary color value signal via a display. The control module stores the three primary color value signal and color model value.

Accordingly, in addition to identifying the color of the object, the colorimetric system can also quantify the color intensity of the object. Thus, the property of the object can be determined accurately.

In the colorimetric system according to the present invention, the control module transmits a control instruction to the processing module to control the processing module to calibrate the three primary color value signal. As such, the colorimetric system can arrange conversion and calibration of data, thus the measurement results can be analyzed.

In the colorimetric system according to the present invention, the processing module transmits a measuring instruction to the sensing module to control the sensing module measure the color intensity of the object. As such, the colorimetric system can plan the measurement process, thus the measurement efficiency can be improved.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 depicts a flow chart of a method for manufacturing a 2-dimensional dimethylglyoxime-iridium (DMG-Ir) nanosheet according to the present invention.

FIG. 2 depicts an ultraviolet (UV)-visible spectrum of the 2-dimensional DMG-Ir nanosheet. A solid line shows a spectral curve of the 2-dimensional DMG-Ir nanosheet, and a dotted line shows a spectral curve of dimethylglyoxime (DMG).

FIG. 3 depicts an X-ray diffraction (XRD) spectrum of the 2-dimensional DMG-Ir nanosheet. “●” shows peaks of element iridium (Ir), and “▪” shows peaks of DMG.

FIG. 4 depicts an image of transmission electron microscopy (TEM) of the 2-dimensional DMG-Ir nanosheet.

FIG. 5 depicts an X-ray photoelectron (XRP) spectrum of the 2-dimensional DMG-Ir nanosheet.

FIG. 6 depicts an Ir 4f deconvolution spectrum according to FIG. 5.

FIG. 7 depicts a C 1s deconvolution spectrum according to FIG. 5.

FIG. 8 depicts a N Is deconvolution spectrum according to FIG. 5.

FIG. 9 depicts an O 1s deconvolution spectrum according to FIG. 5.

FIG. 10 depicts a block diagram of a colorimetric system according to the present invention.

FIG. 11 depicts a calibration curve between color difference detected by a colorimetric system according to the present invention and a concentration of solution.

### DETAILED DESCRIPTION OF THE INVENTION

A 2-dimensional dimethylglyoxime-iridium (DMG-Ir) nanosheet of an embodiment according to the present invention is formed by element iridium (Ir) and DMG. Specifically, the 2-dimensional DMG-Ir is formed by an iridium (Ir) salt and DMG in an alkaline environment.

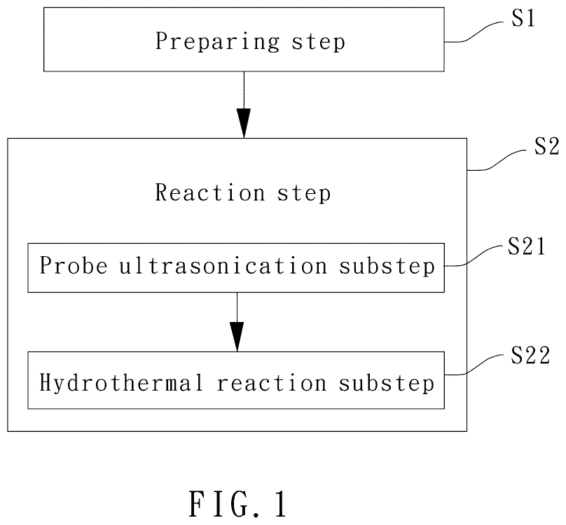

To obtain the 2-dimensional DMG-Ir nanosheet, a method shown in FIG. 1 can be carried out, which comprises: a preparing step S1 and a reaction step S2.

Specifically, in the preparing step S1, the alkaline environment is provided. For example, an alkaline aqueous solution with a pH value ranging from 8.5 to 9.5 can be formed by dissolving a base in water. The base can be any inorganic agent that can completely dissociated and produce hydroxide ion (OH) in water, forming the alkaline aqueous solution with the pH value ranging from 8.5 to 9.5. For example, the base can be potassium hydroxide (KOH), sodium hydroxide (NaOH), etc. In this embodiment, the alkaline aqueous solution is a KOH aqueous solution (0.05 M, 20 mL).

Then, the Ir salt and DMG are dissolved in the alkaline aqueous solution, forming a mixture. The Ir salt can be any Ir (III)-containing inorganic compound, as long as it can be dissolved in the alkaline aqueous solution and can dissociate to form iridium (III) ions (Ir³⁺). In this embodiment, anhydrous iridium trichloride (IrCl₃) is used as the Ir salt.

Moreover, when dissolving the Ir salt and DMG in the alkaline aqueous solution, a predetermined molar ratio between an element iridium (Ir) of the Ir salt and DMG is preferably set, ensuring the element Ir of the Ir salt can react completely with DMG. For example, the predetermined molar ratio between the element Ir of the Ir salt and DMG can be 1:2. In this embodiment, 29.9 mg of IrCl₃ (anhydrous) and 23.2 mg of DMG are added to the KOH aqueous solution (0.05 M, 20 mL) to form the mixture.

In the reaction step S2, the 2-dimensional DMG-Ir nanosheet is formed by the reaction of element Ir of the Ir salt and DMG. Specifically, referring to FIG. 1, the reaction step S2 can comprise an ultrasonication substep S21 and a hydrothermal reaction substep S22.

In the probe ultrasonication substep S21, a probe ultrasonicator with an output power ranging from 45 W to 55 W is used to probe sonicate the mixture. The probe ultrasonicator is set as a pulse mode with a pulse on time of 2 seconds and a pulse off time of 1 second. After a probe of the probe ultrasonicator is introduced into the mixture, the probe ultrasonicator is on, and the mixture is probe ultrasonicated for 10 minutes.

In the hydrothermal reaction substep S22, a hydrothermal reaction to the mixture which is probe ultrasonicated is carried out. For example, the mixture is heated to a temperature ranging from 190° C. to 210° C. for a time period ranging from 20 minutes to 30 minutes with a stirring speed ranging from 550 rpm to 650 rpm, obtaining the 2-dimensional DMG-Ir nanosheet. In this embodiment, the mixture is heated at 200° C. for 20 minutes with a stirring speed of 600 rpm.

To evaluate the product manufacture by the above method is the 2-dimensional DMG-Ir nanosheet, the following analyses are carried out.

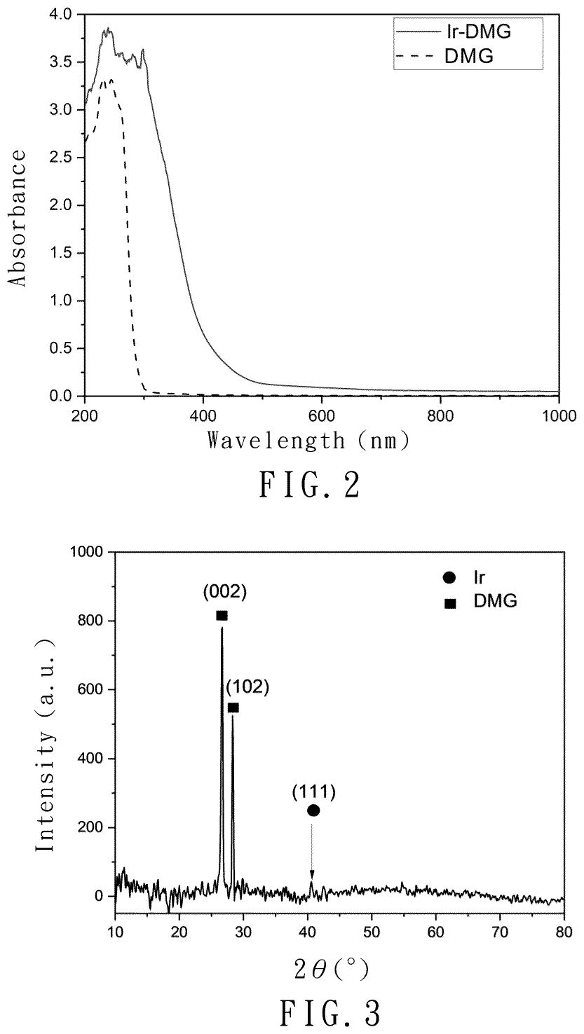

Referring to FIG. 2, according to an ultraviolet (UV)-visible spectrum, the 2-dimensional DMG-Ir nanosheet has peaks which differ from that of DMG (shown by a solid line and a dotted line, respectively), indicating iridium indeed reacts with DMG.

Referring to FIG. 3, according to an X-ray diffraction (XRD) spectrum, the 2-dimensional DMG-Ir nanosheet has peaks corresponding to element Ir, as well as to DMG. Moreover, the obtained XRD spectrum is highly comparative to the previously published DMG-Ni XRD pattern but there is no involvement of Ni in the system. Also, the XRD spectrum shows a unique peak for Ir to confirm the proper crystallization of DMG-Ir as same as the well-known DMG-Ni.

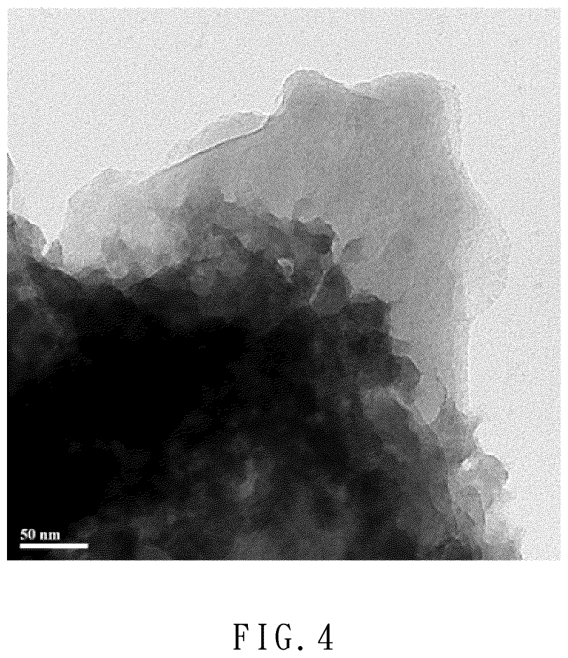

Referring to FIG. 4, according to an image of transmission electron microscopy (TEM), the 2-dimensional DMG-Ir nanosheet has layered sheet structure.

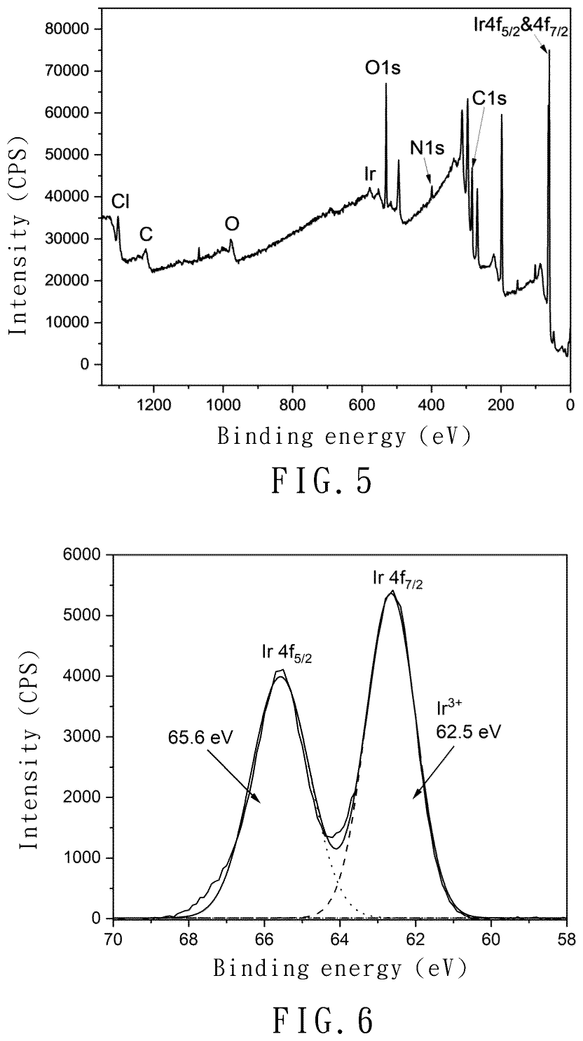

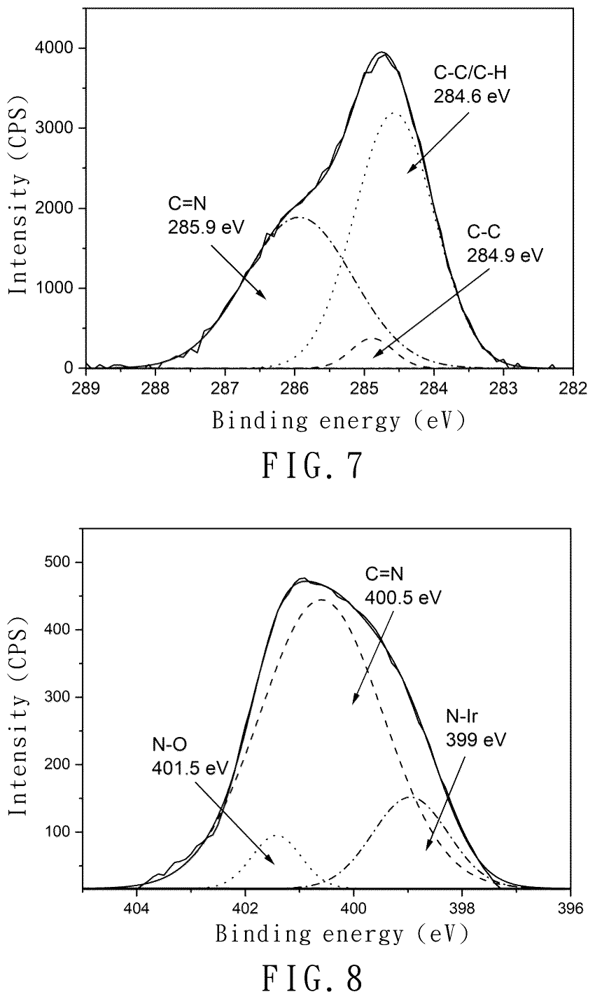

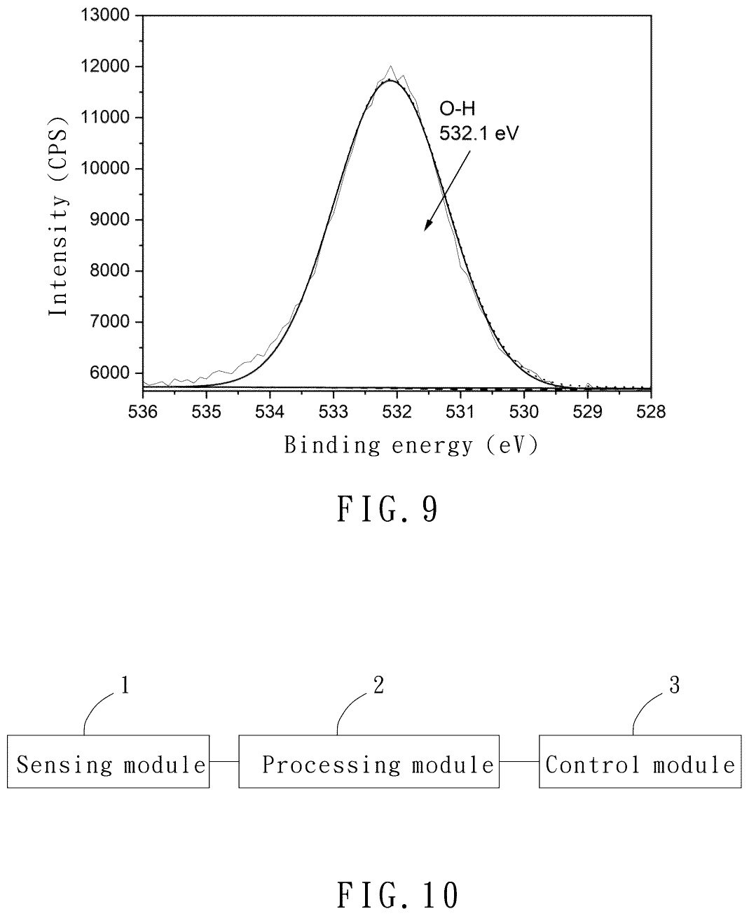

Referring to FIG. 5, according to an X-ray photoelectron (XRP) spectrum, element carbon (C), element nitrogen (N), element oxygen (O), element chloride (Cl) and element iridium (Ir) are present in the 2-dimensional DMG-Ir nanosheet. Moreover, referring to FIGS. 6-9, an oxidation state of element Ir in the 2-dimensional DMG-Ir nanosheet is Ir³⁺, and Ir—N bonding is presence between element Ir and element N, indicating DMG chelates element Ir with its element N to form the 2-dimensional DMG-Ir nanosheet.

Besides, the 2-dimensional DMG-Ir nanosheet can be used for detection of the nickel ions in water. For example, for an aqueous solution containing the nickel ions, after adding the 2-dimensional DMG-Ir nanosheet, the aqueous solution can quickly change color from yellow to crimson red. When used with a conventional UV/visible light spectrum for detection, the linear range is 20 μM to 600 μM (approximately 1.16 ppm to 35.21 ppm), the coefficient of determination (R² value) is 0.99, and the limit of detection (LOD) can reach 0.940 ppm, indicating the 2-dimensional DMG-Ir nanosheet has good reactivity, sensitivity and accuracy for detecting the nickel ions.

Referring to FIG. 10, a colorimetric system of an embodiment according to the present invention comprises a sensing module 1, a processing module 2 and a control module 3. The processing module 2 separately couples the sensing module 1 and the control module 3.

The sensing module 1 can comprise a lighting unit and a sensing unit. The lighting unit is used to light an object, and the sensing unit is used to measure a color intensity of the object, forming an analog signal. The object can be an aqueous solution with the 2-dimensional DMG-Ir nanosheet, and according to the concentration of the nickel ion of the aqueous solution, the corresponding color intensity can be measured. The sensing unit can sense full visible wavelength range such as 400 nm to 680 nm. The sensing unit is capable of receiving constant light intensity and measuring the differences between the various objects.

The processing module 2 can be a microcontroller for receiving the analog signal of the sensing module 1, converting the analog signal to a digital signal, and calibrating a frequency of the digital signal into a three primary color value signal. The processing module 2 can also produce a measuring instruction and transmit the measuring instruction to the sensing module 1 to control the sensing module 1 to fill light and to measure the color intensity of the object. The processing module 2 can calibrate and provide the corresponding RGB values by the microcontroller, such as the Arduino's product.

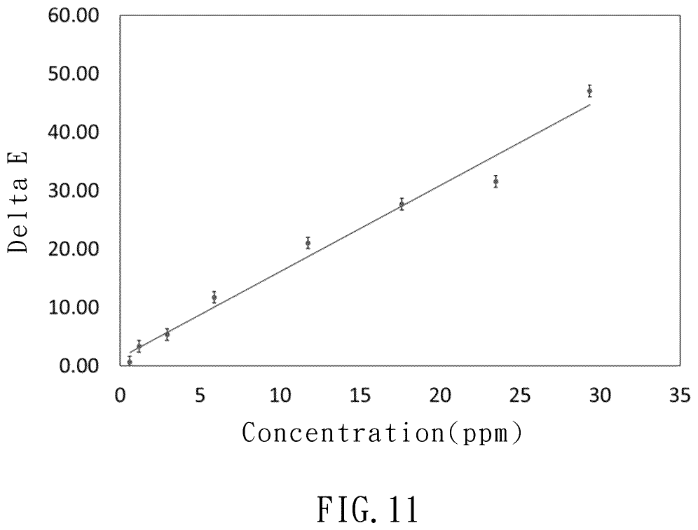

The control module 3 can be a computer performing a calculation software. The control module 3 is used to receive and verify the three primary color value signal. The control module 3 further comprise a display to display the three primary color value signal. The control module 3 can further convert the three primary color value signal into a color model value via algorithm. The color model can be the CIELAB color space (L*a*b*) defined by International Commission on Illumination (CIE). The control module 3 can store the three primary color value signal and the color model value in a spreadsheet format. With such performance, the colorimetric system can accurately quantify the color intensity of the object to be measured. In this embodiment, referring to FIG. 11, the color space CIE L*a*b* is used to compare the color difference between solutions of different concentrations. Specifically, the color of an aqueous solution to be measured (with the 2-dimensional DMG-Ir nanosheet and without nickel ions) is used as a reference point. The color of the various solutions to be measured (with the 2-dimensional DMG-Ir nanosheet and with different but known concentrations of nickel ions) is measured. The difference between the color of the aqueous solution to be measured with known concentration of nickel ions (with the 2-dimensional DMG-Ir nanosheet) and the reference point is calculated as ΔE. The linear regression analysis on the relationship between the plurality of values of ΔE and corresponding concentrations is performed, and the result shows the linear range is 20 μM to 600 μM (approximately 1.16 ppm to 35.21 ppm), the coefficient of determination (R² value) is 0.98, and the limit of detection can reach 0.0498 ppm. Therefore, the color difference ΔE of the aqueous solution to be measured is highly correlated to the concentration of the aqueous solution to be measured, and the limit of detection of the colorimetric system is lower than conventional spectrometer UV/visible light spectrum. So, the colorimetric system can be used to quantify the ion concentration in the solution. The control module 3 can further produce a control instruction and transmit to the processing module 2 to control the processing module 2 to covert and to calibrate the three primary color value signal.

Accordingly, by the above method, the 2-dimensional DMG-Ir nanosheet can be manufactured. The 2-dimensional DMG-Ir nanosheet can form a coordination complex with the nickel ions, so that the color of the aqueous solution containing the nickel ions can quickly change from yellow to crimson red. That is, the two-dimensional DMG-Ir nanosheet can be used for detection of the nickel ions with a preferable detection efficiency.

Moreover, in addition to identifying the color of the object, the colorimetric system can also quantify the color intensity of the object. Thus, the property of the object can be determined accurately.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A method for manufacturing a 2-dimensional dimethylglyoxime-iridium (DMG-Ir) nanosheet, comprising performing a reaction between an iridium (Ir) salt and dimethylglyoxime (DMG) in an alkaline environment.

2. The method for manufacturing the 2-dimensional DMG-Ir nanosheet as claimed in claim 1, wherein the alkaline environment has a pH value ranging from 8.5 to 9.5.

3. The method for manufacturing the 2-dimensional DMG-Ir nanosheet as claimed in claim 2, wherein the alkaline environment is provided by an alkaline aqueous solution.

4. The method for manufacturing the 2-dimensional DMG-Ir nanosheet as claimed in claim 3, wherein the alkaline aqueous solution is formed by dissolving a base in water, and the base is potassium hydroxide (KOH) or sodium hydroxide (NaOH).

5. The method for manufacturing the 2-dimensional DMG-Ir nanosheet as claimed in claim 1, wherein performing the reaction between the Ir salt and DMG comprising:
dissolving the Ir salt and DMG in an alkaline aqueous solution to form a mixture; and
after performing a probe ultrasonication to the mixture with a pulse on time and a pulse off time for a predetermined sonicating time, performing a hydrothermal reaction to the mixture.

6. The method for manufacturing the 2-dimensional DMG-Ir nanosheet as claimed in claim 5, wherein when dissolving the Ir salt and DMG in the alkaline aqueous solution, a molar ratio between element iridium (Ir) of the Ir salt and DMG is 1:2.

7. The method for manufacturing the 2-dimensional DMG-Ir nanosheet as claimed in claim 5, wherein the probe ultrasonication is performed with an output power ranging from 45 W to 55 W.

8. The method for manufacturing the 2-dimensional DMG-Ir nanosheet as claimed in claim 7, wherein the pulse on time is 2 seconds, the pulse off time is 1 second, and the predetermined sonicating time is 10 minutes.

9. The method for manufacturing the 2-dimensional DMG-Ir nanosheet as claimed in claim 5, wherein the hydrothermal reaction is performed at a temperature ranging from 190° C. to 210° C. for a time period ranging from 20 minutes to 30 minutes with a stirring speed ranging from 550 rpm to 650 rpm.

10. The method for manufacturing the 2-dimensional DMG-Ir nanosheet as claimed in claim 9, wherein the hydrothermal reaction is performed at a temperature of 200° C. for a time period of 20 minutes with a stirring rate of 600 rpm.

11. A 2-dimensional dimethylglyoxime-iridium (DMG-Ir) nanosheet, manufactured according to a method as claimed in claim 1.

12. A colorimetric system, comprising:
a sensing module, wherein the sensing module measures a color intensity of an object and converts the color intensity to an analog signal;
a processing module coupling to the sensing module, wherein the processing module receives the analog signal, converts the analog signal to a digital signal, and calibrates the digital signal into a three primary color value signal; and
a control module coupling to the processing module, wherein the control module receives and verifies the three primary color value signal, wherein the control module converts the three primary color value signal to a color model value, wherein the control module displays the three primary color value signal via a display, and wherein the control module stores the three primary color value signal and the color model value.

13. The colorimetric system as claimed in claim 12, wherein the control module transmits a control instruction to the processing module to control the processing module to calibrate the three primary color value signal.

14. The colorimetric system as claimed in claim 12, wherein the processing module transmits a measuring instruction to the sensing module to control the sensing module measure the color intensity of the object.
